(19) United States
(12) Patent Application Publication
(10) Pub. No.: US 2002/0156609 A1
(43) Pub. Date: Oct. 24, 2002

(54) Circuit simulation method, circuit simulation device, and circuit simulation program and computer readable storage medium onto which the program is stored

(75) Inventors: Kyoko Hirata, Osaka (JP); Hiroshi Shimomura, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/125,441

(22) Filed: Apr. 19, 2002

(30) Foreign Application Priority Data
Apr. 19, 2001 (JP) 2001-120652

(51) Int. Cl. G06F 17/50

(52) U.S. Cl. 703/14

(57) ABSTRACT

The present invention provides a circuit simulation method for a semiconductor device in which the circuit configuration is specified by a netlist. First, variations in the layout pattern and arrangement of elements used in the semiconductor device are formulated into an equation including parameters (S110). Next, the parameters included in the equation are put into element parameter groupings corresponding to each element, and the element parameter groupings are stored in storage means (S120). Then, the parameters in the element parameter groupings are varied in accordance with the conditions obtained from variations in manufacturing process with respect to the semiconductor device (S130). Then, these varied parameters are used to execute a circuit simulation with processing means (S140).

### BACKGROUND OF THE INVENTION

The present invention relates to a circuit simulation method and a circuit simulation device, and in particular to a circuit simulation method for simulating variations in circuit properties due to variations in the elements of a semiconductor device. The present invention also relates to a circuit simulation program and a computer readable storage medium onto which that program is stored.

Recent progress in system LSI developments targeting one-chip solutions have lead increases in circuit scale and further advances in the miniaturization of semiconductor processing. Moreover, there is a increasing demand for low energy consumption, and circuit designs in which the LSI power supply voltage is low have become necessary. If the LSI power supply voltage is low in analog circuits, then the voltage range at which transistors, for example, can operate is narrowed, and thus analog circuits require designs that are even more precise than digital circuit designs. An excess operating margin cannot be taken if high precision designs are to be achieved.

Furthermore, as the miniaturization of semiconductor processing progresses, variations, for example, in the layout pattern, arrangement, and fabrication process of circuit elements have come to considerably affect circuit performance, and in analog circuits this impact is particularly large. For example, even a minor fluctuation in the electrical properties of a circuit element caused by a drop in power source voltage may have an effect on circuit properties.

For these reasons, it is desirable to implement a simulation that reflects the detailed electrical properties, such as the layout pattern or arrangement of the circuit elements, variations between chips, variations in the silicon wafer, variations between wafers, and variations between lots. It is preferable that simulations reflecting detailed element properties are also performed to achieve high-precision circuits and to ascertain a proper margin for the circuit, and that by doing so, the range of fluctuation in circuit properties is accurately grasped. To date, however, a method capable of easily simulating these detailed circuit properties has yet to be developed.

A method generally used for simulating circuit properties is SPICE (Simulation Program with Integrated Circuit Emphasis), the source code of which has been made available to the public. SPICE is a universal electronic circuit simulation program developed at UCB (University of California, Berkeley Campus, USA). To execute simulations that take variations into account using SPICE, the following procedure may be adopted. First, each of the elements in a circuit is substituted with a certain physical model and the properties of the elements are parameterized based on that model. Next, variations in the model parameters are used for property variations of each element, a variation range is assigned to the model parameters of the elements, and the circuit properties are simulated within that range, whereby the variation range of the circuits is obtained. Element variations include an absolute variation and a relative variation. Here, absolute variation refers to variation defined by a maximum variation at which the element parameter variation in each of the elements is a maximum value and a minimum variation at which the variation is a minimum value, whereas relative variation refers to variation defined by variations between elements when a plurality of elements proximately disposed on a semiconductor integrated circuit are regarded as elements consistent with one another.

Conventionally, a variety of approaches have been examined for varying the model parameters of the elements. Specifically, Japanese Laid-Open Patent Publication No.10-240788 discloses a technique for worst-case analysis in which a simulation is performed so that circuit properties are met for all variation ranges. Additionally, Japanese Laid-Open Patent Publication No. 10-240796A discloses a technique for performing worst-case analysis after the wiring capacity or wiring resistance in the circuit is parameterized to establish the variation range.

Referring to FIG. 5, the circuit simulation method by worst-case analysis disclosed in JP H10-240788A will be described below.

First, parameter values of a prepared element model or circuit simulation conditions are set with an input device 304 (S301). Data on relative assignments indicating mutually consistent elements, in addition to circuit connection information and analysis conditions used in the circuit simulation and the range of variation consisting of the absolute variation range and the relative variation range of the resistive element, are stored in the input device 304.

Next, the circuit simulation is performed based on the established circuit data or the simulation model for the elements (S302), and the results obtained by the simulation are then output (S303). When simulating variations in the circuit output, the circuit simulation is executed after resetting the values of the model parameters.

That is to say, with the technique shown in FIG. 5, the relative variation is obtained from the range in variation in parameters of the prepared element models, the worst-case variation range of the maximum and minimum values that can be taken for each element is obtained from the combination of the absolute variation, and then the circuit simulation is performed.

When the above conventional technique is used, however, the inventor of the present invention found that there were the following problems. These are that the above conventional technique requires that the range in variation for each element constituting the circuit and the elements for which the relative variation is to be considered are set individually, so that the settings must be changed each time one wishes to change the parameters of the element model, the values of the parameters, or the range of fluctuation, which is very inconvenient. Furthermore, the parameters in the models are complex, making it practically impossible to vary a plurality of parameters in a single model in accordance with actual physical operations, and thus each parameter in a single model cannot be automatically correlated. Moreover, it is not possible to conduct circuit simulation including error parameters considering the layout pattern.

Additionally, relative error in the properties of close elements is an important characteristic that should be considered in analog circuit design. With the above conventional technique, however, simulations considering the relative error of close elements or those considering manufacturing variations cannot be performed automatically. Also, simulations cannot be performed in which certain elements in the circuit are grouped and then the parameters of certain relative error or absolute error are assigned to that group, nor can variations in circuit properties be simulated giving consideration to the relation between the relative distance and variation between the circuit elements.

Although there is a trade-off between simulation precision and simulation time, conventional techniques do not allow for the time of the circuit simulation to be shortened even if the elements key in determining circuit precision and the elements where precision is not so important are known in advance. This is because in conventional techniques, the precision of the fit between the parameters for variations in each element and the data on variations in the elements actually manufactured cannot be freely changed. Additionally, conventional techniques do not allow simulations of the elements constituting a circuit by grouping functional blocks or those elements always arranged in the layout within a certain distance and then setting a certain range of variation.

### SUMMARY OF THE INVENTION

This invention has been achieved in light of these various problems, and it is a primary object thereof to very precisely and easily execute a circuit simulation that considers variations in circuit properties.

A circuit simulation method according to the present invention is a circuit simulation method for a semiconductor device in which the circuit configuration is specified by a netlist, and includes the steps of formulating variations corresponding to a layout pattern and an arrangement of elements used in the semiconductor device into an equation including parameters, putting the parameters included in the equation into element parameter groupings corresponding to each element, and storing the element parameter groupings in storage means, varying to parameters in the element parameter groupings, in accordance with conditions obtained from variations in the manufacturing process with respect to the semiconductor device, and executing a circuit simulation by processing means using the parameters that have been varied.

In an embodiment of the present invention, the step of allowing relative error parameters expressed using the size of proximate elements and the relative distance between proximate elements to be included in the element parameter groupings is executed when putting the parameters included in the equation into the element parameter groupings corresponding to each element.

In an embodiment of the present invention, the relative error parameters include variations in the wafer surface, variations between wafers, and variations between lots in the manufacturing process.

In an embodiment of the present invention, the step of executing a circuit simulation includes the steps of creating a simulation model including variations corresponding to layout parameters and arrangement of elements used in the semiconductor device, element size, distance between elements, and the manufacturing process, and executing a circuit simulation using the simulation model.

In an embodiment of the present invention, the formulating step further includes a fitting step of fitting the parameters to conform to actual element properties, and the fitting step includes the step of arbitrarily setting a fitting precision during fitting.

In an embodiment of the present invention, the step of creating a simulation model further includes a fitting step of fitting the parameters to conform to actual element properties, and the fitting step includes the step of arbitrarily setting a fitting method and a fitting precision during fitting.

In an embodiment of the present invention, arbitrary parameters of the parameters are provided with values related to one another.

In an embodiment of the present invention, the parameters of each element are grouped as an arbitrary group, and the parameters are varied at each of the groups.

In an embodiment of the present invention, the relative error parameters are grouped as an arbitrary group, and the parameters are varied at each of the groups.

In an embodiment of the present invention, the elements in the circuit to be simulated are grouped as an arbitrary group and predetermined parameters in a predetermined group are varied to an arbitrary precision and for an arbitrary range.

In an embodiment of the present invention, a predetermined number of simulations are then performed after the parameters are varied at pre-designated ranges and conditions, and then results that are output for a designated site on the circuit are monitored and the sensitivity with respect to the monitored site is analyzed.

In an embodiment of the present invention, sequentially changed values are set for the parameters.

In an embodiment of the present invention, the circuit simulation method further includes the step of performing numerical simulation of the circuit output obtained by the step of executing the circuit simulation, and outputting using function description language.

In an embodiment of the present invention, the semiconductor device in which a circuit configuration is specified by a netlist includes an analog circuit or an analog/digital mixed circuit.

A circuit simulation device according to the present invention includes input means for inputting at least one of or all element information selected from the group consisting of element size, layout pattern, element arrangement conditions, and element grouping information; process data storage means for storing process data, including element conditions for defining an element included in a semiconductor device to be manufactured and variations thereof; processing means for creating, based on the process data and the element information, a simulation model including at least one of or all simulation model parameters selected from the group consisting of property parameters of each element, correlating data between parameters, variation width of each element, element arrangement parameters, and fluctuation conditions for each parameter, and simulation model storage means for storing the simulation model. The processing means uses the simulation model and the netlist specifying the circuit configuration of the semiconductor device to be manufactured in order to execute a circuit simulation.

In an embodiment of the present invention, the circuit simulation device further includes a function of enabling element parameters that include variation information and correspond to a layout pattern and arrangement of the elements used in the semiconductor device to be set for each semiconductor manufacturing process or for each design rule; and a function of simulating variations in circuit properties caused by variations between elements, after turning the set element parameter groupings into files and varying to the element parameters by a prescribed method.

In an embodiment of the present invention, the circuit simulation device further includes netlist creating means for creating a netlist specifying a circuit configuration of a semiconductor device to be manufactured, netlist editing means for editing the netlist by using the element information input by the input means, and simulation condition setting means for setting simulation conditions when executing the circuit simulation.

In an embodiment of the present invention, the circuit simulation device further includes simulation condition storage means for storing the simulation conditions, and the simulation condition setting means has a function of enabling the simulation conditions stored in the simulation condition storage means to be changed, and the processing means repeatedly executes a circuit simulation based on the simulation conditions or simulation conditions that have been changed by the simulation condition setting means.

In an embodiment of the present invention, it further includes output means for outputting results obtained from the circuit simulation executed by the processing means.

In an embodiment of the present invention, the output means outputs the results of the execution as an AHDL model including variations in circuit properties.

Another circuit simulation method according to the present invention includes the steps of creating a netlist specifying a circuit configuration of a semiconductor device by circuit netlist creating means; inputting at least one of or all element information selected from the group consisting of element size, layout pattern, element arrangement conditions, and element grouping information by input means; editing the netlist with circuit netlist editing means by using the element information inputted by the input means; creating a simulation model for each element including variation information with processing means by using the element information and process data that are stored in process data storage means and include element conditions for defining an element included in the semiconductor device to be manufactured and variations thereof; storing the created simulation model in storage means; executing a circuit simulation with the processing means for executing a circuit simulation program, by using the netlist edited by the circuit netlist editing means and the simulation model stored in the storage means; and outputting results of the circuit simulation to output means.

In an embodiment of the present invention, the step of creating a simulation model is the step of creating a simulation model that has at least one of or all simulation model parameters selected from the group consisting of property parameters of each element, correlating data between parameters, variation width of each element, element arrangement parameters, and fluctuation conditions for each parameter.

In an embodiment of the present invention, the step of setting simulation conditions selected from the group consisting of circuit simulation type, power source voltage, power source fluctuation value, and designating which parameter to vary is executed before the step of performing the circuit simulation is executed.

In an embodiment of the present invention, the step of setting the simulation conditions is executed after the outputted results for the circuit simulation are evaluated, and then the step of performing the circuit simulation once again is executed.

In an embodiment of the present invention, the step of setting the simulation conditions is automatically executed after the step of performing the circuit simulation, and then the step of performing the circuit simulation is performed repeatedly.

In an embodiment of the present invention, the outputting step includes the step of outputting the results of the circuit simulation as an AHDL model.

In an embodiment of the present invention, the step of creating the netlist is creating a netlist that specifies the circuit configuration of a semiconductor device including an analog circuit or an analog/digital mixed circuit.

A circuit simulation program according to the present invention is a circuit simulation program to be implemented by a computer and includes the functions of editing a netlist stored in storage means included in the computer, using at least one of or all element information selected from the group consisting of element size, layout pattern, element arrangement conditions and element grouping information, the element information being inputted by input means; creating a simulation model for each element including variation information by editing at least one or all selected from the group consisting of property parameters of each element, correlating data between parameters, variation width of each element, and the conditions for parameter fluctuation due to the element arrangement, using the element information and process data that are stored in storage means of the computer and include element conditions for defining an element included in a semiconductor device to be manufactured and variations thereof; setting simulation conditions selected from the group consisting of circuit simulation type, power source voltage, power source fluctuation value, and designating which parameters to vary; executing a circuit simulation by a circuit simulation program stored in storage means, based on the set simulation conditions and the simulation model; and outputting the results of the circuit simulation to output means.

In an embodiment of the present invention, the netlist stored in the storage means is a netlist for specifying the circuit configuration of a semiconductor device including an analog circuit or an analog/digital mixed circuit.

In an embodiment of the present invention, the circuit simulation program further includes a function for storing simulation conditions when executing the circuit simulation, automatically changing the stored simulation conditions, and then repeatedly executing the step of performing the circuit simulation once again.

In an embodiment of the present invention, the function for outputting is provided with a function for outputting the results of the circuit simulation as an AHDL model.

A storage medium readable by a computer according to the present invention is a storage medium onto which the above simulation program has been stored.

According to the present invention, a circuit simulation considering variations in circuit properties can be executed very precisely and simply. As a result, variations in properties that occur due to the layout, for example, become apparent before layout, and thus factors that were confirmed after production can be known in advance, design times can be significantly shortened, and design precision can be increased. Thus, it is possible to provide analog circuit semiconductor devices with better performance and higher reliability than conventional devices. Additionally, lowered manufacturing costs for semiconductor devices and reduced development and manufacturing times can be achieved.

### BRIEF DESCRIPTION OF THE DRAWINGS

FIG. 1 is a flowchart showing a circuit simulation method according to an embodiment of the present invention.

FIG. 2 schematically shows an example of the configuration of the circuit simulation device according to an embodiment of the present invention.

FIG. 3A is a conceptual drawing of the circuit data, the circuit elements, and the element group.

FIG. 3B is conceptual drawing of the element parameter groupings, the element parameters, and the element parameter groups.

FIG. 4 is a flow chart for describing the circuit simulation method according to an embodiment.

FIG. 5 is a flow chart for describing a conventional circuit simulation method.

### DESCRIPTION OF THE PREFERRED EMBODIMENTS

Hereinafter, embodiments of this invention will be described with reference to the accompanying drawings. The invention is not, however, limited thereto.

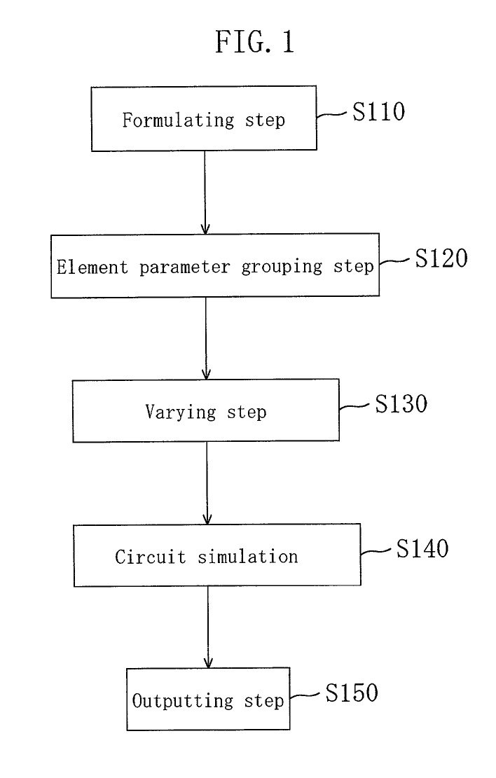

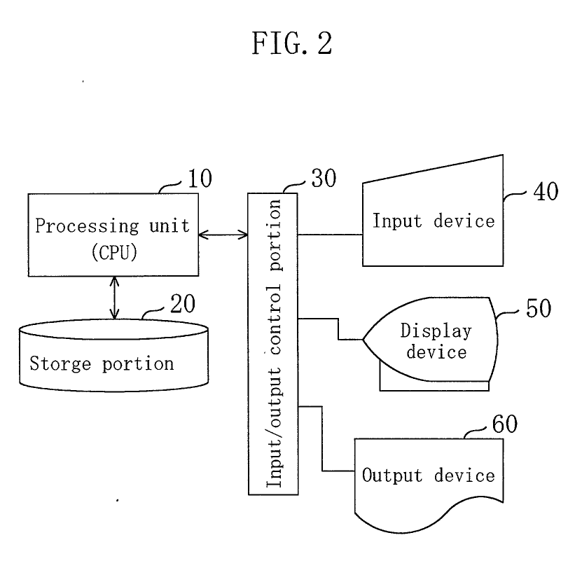

FIG. 1 shows a flowchart of a circuit simulation method according to this embodiment. FIG. 2 schematically shows the configuration of a device for executing the circuit simulation method of this embodiment. The device shown in FIG. 2 includes a processing unit (CPU) 10 functioning as processing means, a storage device 20 functioning as storing means, an input device 40 functioning as input means, and a display device 50 and an output device 60 functioning as output means.

The processing unit (CPU) 10 is connected to the storage device 20, and the input device 40, the display device 50 and the output device 60 are connected to the processing unit 10 via an input/output control portion 30. It should be noted that the processing unit 10 may also include the function of the input/output control portion 30. These components work cooperatively one another to function as a circuit simulation device for executing the circuit simulation method of the present embodiment. In particular, the processing unit (CPU) 10 can achieve several different means based on various programs or data stored in the storage device 20.

The circuit simulation method in this embodiment is for the circuit simulation of a semiconductor device in which the circuit structure is specified by a netlist. In this embodiment, circuit simulation is performed for a semiconductor device including an analog circuit (or an analog/digital mixed circuit), where an even more precise simulation is required. It is of course possible for circuit simulation to be performed for not only analog circuits but digital circuits as well.

The circuit simulation method of the present embodiment is performed as follows.

First, variations corresponding to the layout pattern and the arrangement of elements used in the semiconductor device are formulated into an equation including parameters (S110). Next, the parameters included in the equation are put into element parameter groupings for each of the elements, and the element parameter groupings are stored in the storage device 20 (S120). The conditions obtained from variations in the manufacturing process for the semiconductor device are then used to generate variations in the parameters of the element parameter groupings (S130). The parameters varied in step S130 are then used to perform a circuit simulation with the processing unit 10 (S140). When step S140 is complete, the results of the simulation are output to the display device 50 or the output device 60 (S150).

Thus, in the present embodiment, the parameters are put into element parameter groupings corresponding to each of the elements, the parameters of the element parameter groupings are subsequently varied with the conditions obtained from variations in the manufacturing process of the semiconductor device, and then circuit simulation is performed. Consequently, variations in circuit properties caused by variations between elements can be obtained by the simulation.

In step S110, variations corresponding to the layout pattern and the arrangement of the elements used in the semiconductor device are formulated into an equation including parameters. This equation is as follows. For example, if the element used for the semiconductor device is a transistor, then variations in the relative precision of the threshold voltage Vt, which is one property of transistors, can be expressed by the following equation including parameters:

ΔVt=A_{VT}×tₒₓ/(WL)^{1/12}

where, ΔVt is the standard deviation of the threshold voltage Vt, A_{VT} is the coefficient obtained from the processing conditions, tₒₓ is the thickness of the gate oxide film, W is the gate width of the transistor, and L is the gate length of the transistor. In step S110, variations in the layout pattern and arrangement of elements other than the transistor, such as the resistor element, the capacity element, and the power source element, are also formulated into an equation including parameters.

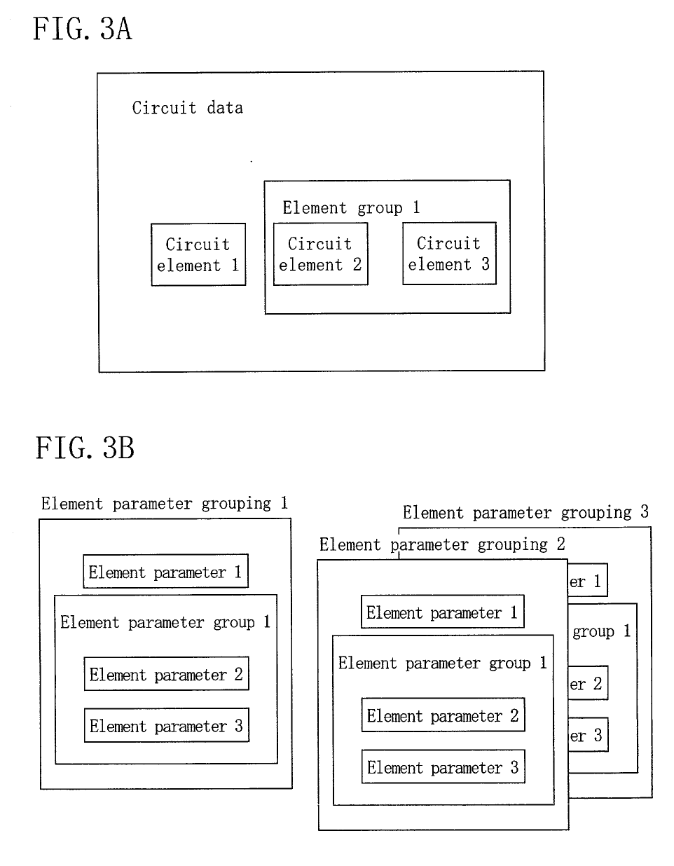

After step S110, parameters included in the equation (for example, tₒₓ, W, L) are put into element parameter groupings corresponding to each element. Element parameter groupings are described conceptually in FIGS. 3A and 3B.

FIG. 3A illustrates a conceptual diagram of circuit data in which the circuit configuration is specified by a netlist, and circuit elements (transistor, etc.) within the circuit data. In the example shown in FIG. 3A, there are circuit elements 1 to 3 within the circuit data, and the circuit elements 2 and 3 form an element group 1. Next, FIG. 3B shows a conceptual diagram of element parameter groupings 1 to 3. The element parameter grouping 1 is a grouping of the parameters corresponding to the circuit element 1.

In the example shown in FIG. 3B, the element parameter grouping 1 includes the element parameters 1 to 3, and here the element parameters 2 and 3 make up the element parameter group 1. Which element parameters are to be treated as element parameter groups can be appropriately decided by the user, for example. Like the element parameter grouping 1, the element parameter groupings 2 and 3 constituting the element group 1 are groupings in which parameters corresponding to the circuit elements 2 and 3, respectively, have been grouped as a single grouping. In this example, the element parameter groupings 2 and 3 also each include the element parameter 1 and the element parameters 2 and 3 constituting the element parameter group 1. The element parameter groupings 1 to 3 are stored in the storage device 20 in step S120 to be used in later steps.

When element parameters are put into element parameter groupings corresponding to the elements, as shown in FIG. 3B, it is possible to execute a process for including relative error parameters in the element parameter groupings. Here, relative error parameters are parameters expressed using the size of close elements and the relative distance between close elements. Using these relative error parameters to perform the circuit simulation makes it possible to execute a very precise analog circuit simulation. Relative error parameters in this embodiment include variations in the wafer surface, variations between wafers, and variations between lots in the manufacturing process. Thus, a favorable circuit simulation closer to actual element properties can be executed.

After step S120, the element parameters in the element parameter groupings are be varied with the conditions obtained from the variations in the manufacturing process for the semiconductor device. Variations in the manufacturing process for the semiconductor device are, for example, the variations in gate oxide film thickness and variations in impurity concentration of the semiconductor in a case where the circuit element of the element parameter grouping is a transistor and the element parameter is the threshold voltage Vt, in which case the threshold voltage Vt is varied with the conditions obtained from these variations.

After the variation step S130, the parameters varied are used in executing the circuit simulation with the processing means. In this embodiment, the circuit simulation step S140 creates a simulation model including the layout parameters and arrangement of elements used in the semiconductor device, element size, distance between elements, and variations in the manufacturing process, and then uses this simulation model to execute the circuit simulation. For the circuit simulation, a commercially available circuit simulation tool such as SPICE can be utilized.

A fitting step can also be performed when the simulation model is created, so as to conform element parameters to fit actual element properties. In the case of performing the fitting process, a step can be provided in which the user arbitrarily sets the method for fitting and the fitting precision during fitting. Additionally, the fitting process can be performed at the time of the above-mentioned formulation process instead of when the simulation model is created. Performing the fitting process makes it possible to execute a more accurate circuit simulation, and moreover, by arbitrarily setting the fitting method and the precision, it is possible to execute the circuit simulation in a relatively fast processing time.

To execute circuit simulation at a fast processing speed while maintaining high precision, it is possible to provide arbitrary parameters of the element parameters shown in FIG. 3B with values related to each other. Furthermore, it is possible to group the parameters of each element as an arbitrary group and vary the parameters at each group. In the example shown in FIG. 3B, the process can be conducted such that only the parameters of the element parameter groups 1 are varied. It is also possible to group the relative error parameters as an arbitrary group and vary the parameters at each the respective groups, or to group the elements in the circuit to be simulated as an arbitrary group (for example, the element group 1) and vary predetermined parameters in the predetermined group at an arbitrary precision and within an arbitrary range. Giving a degree of freedom to the method for variation in this manner makes it possible to achieve a circuit simulation method with a fast processing speed that also maintains a high precision.

The results of step S140 are outputted to the display device 50 and/or the output device 60 in step S150. In step S150, it is also possible to further execute a process for performing numerical simulation of the circuit output obtained in step S140 and outputting using function description language. Outputting using function description language has the advantage of increasing convenience when using the circuit block in which the simulation is performed as a component of a separate circuit.

It should be noted that the step S150 is not limited to one time and can be performed a plurality of times. In this case, for example, the simulation can be performed a predetermined number of times in step S140 after the parameters have been varied within a designated range and at designated conditions in step S130. Additionally, in each of predetermined number of simulations, it is possible to monitor, with the display device 50, the results output from a specified site on the circuit and execute a process to analyze sensitivity with respect to the monitored site. Furthermore, it is possible to automatically or manually perform a process for setting the sequentially changed values as the parameters in each of the predetermined number of simulations. Through these steps, a simpler circuit simulation can be performed.

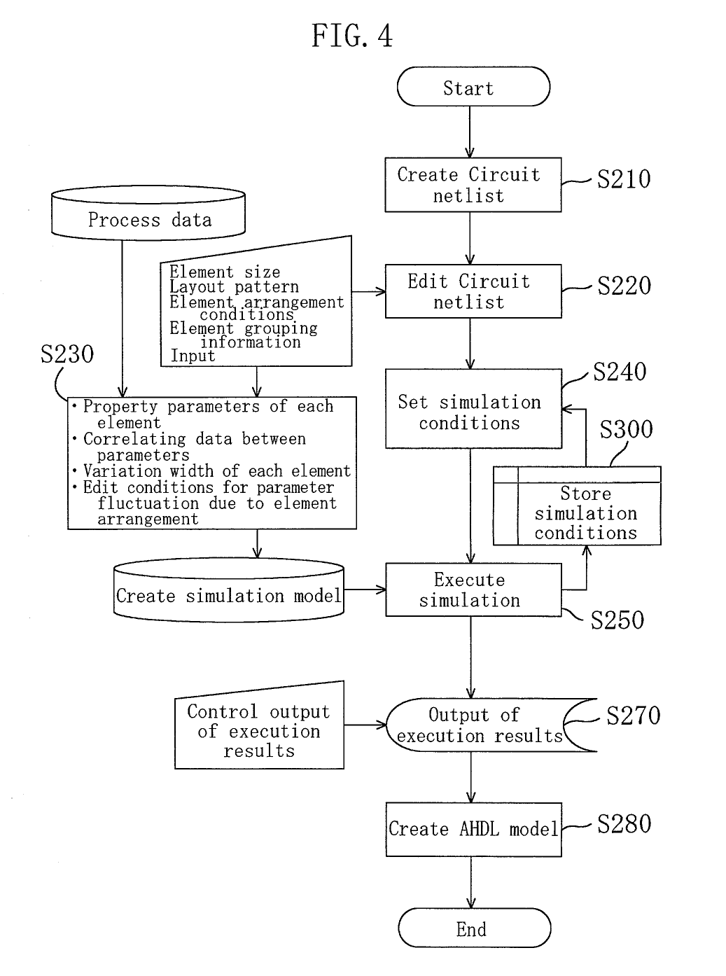

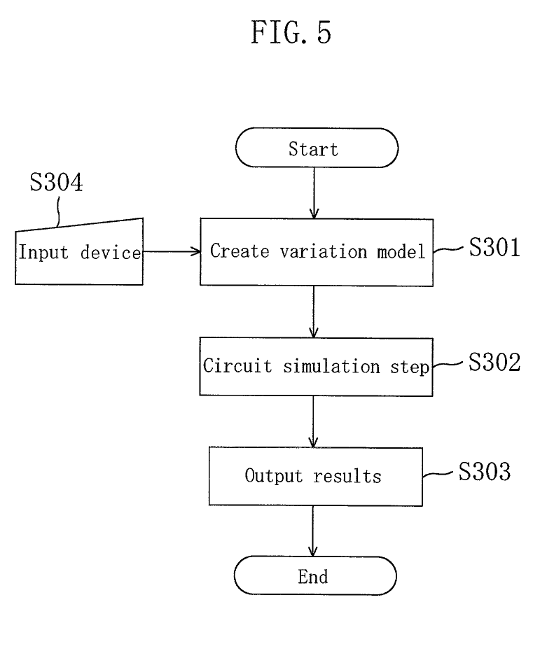

Nest, the circuit simulation method according to this embodiment will be described in more detail with reference to FIG. 4. FIG. 4 is a flowchart showing an example of a circuit simulation method according to this embodiment.

First, a netlist specifying the circuit configuration of the semiconductor device is created by circuit netlist creating means (step S210). In step S210, information on the circuit elements or the power source connection of the semiconductor device for which the simulation is performed is input and thereby described as a netlist. For the circuit netlist creating means, a commercially available tool such as Artist (trademark name) by Cadence Design Systems can be used.

Next, element information such as element size and element arrangement conditions is input with the input device 40 and the element information that has been input is used to edit the circuit netlist with netlist editing means (step S220). In step S220, the size, layout pattern, and element arrangement, for example, of the elements can be designated. More specifically, it is possible to designate which layout pattern for resistive elements of the predetermined patterns is adopted or to designate the resistance length, the resistance width, and how contact is made to the wiring, for example, which are parameters that express the element shape.

Also, in step S220, depending on the circuit, elements can be made into groups as shown in FIG. 3A and information on this grouping can be inputted. For example, transistors in a current mirror circuit that requires similarity in the circuit are closely arranged, and therefore this information is input or edited in step S220. In this case, it is possible to input values based on the actual layout, or only the information on the grouping of the closest arrangement, as the information on the distance between elements.

Next, in step S230, necessary element information is read out from the process data stored in advance in the storage device (hard disk, for example) 20 based on the element information input in step S220. The stored process data includes element conditions for defining the element included in the semiconductor device to be manufactured and variations thereof For example, if the circuit element is a transistor, then the gate oxide film thickness and variations thereof and the impurity concentration of the semiconductor and variations thereof are stored in the storage device 20 as its process data. Next, the process data that are read out are used to compute, with the processing unit 10, the property parameters of each element, correlating data between parameters, variation width of each element, the conditions for parameter fluctuation due to element arrangement and the like. These values are then used as the simulation model parameters. In other words, the simulation model parameters include the property parameters of the elements, the correlating data between parameters and the like. The simulation model is created based on these model parameters, and is stored in the storage device 20.

Next, in step S240, the conditions when executing the simulation, such as the type of circuit simulation, the power source voltage, the voltage fluctuation value, or which parameters to vary, for example, are set. Step S240 can also be performed concurrent to step S230.

After step S240, the circuit simulation is executed in step S250. The variation conditions can be changed by returning to step S240 and performing settings once again. If it is desired to repeat the circuit simulation with different simulation conditions, in step S300 the simulation conditions can be stored in the storage device 20 to repeat the circuit simulation.

After this, in step S270, the results of the simulation can be output by, for example, computing the results of the simulation executed in step S250 and inputting the conditions for plotting these results on a graph from the inputting device 40. Lastly, in step S280, an AHDL model that includes the variations in circuit properties is created from the results output in step S270. An AHDL model refers to a model based on analog function description language, and making an AHDL model has the advantage of producing more efficient, shorter, and simpler analog/digital mixed simulations.

A circuit simulation device suitable for executing this circuit simulation method can be configured using a computer device provided with the processing unit (CPU) 10, the storage device 20, the input device 40, and the display device 50 and/or the output device 60, as shown in FIG. 2. The circuit simulation device according to this embodiment is provided with the processing unit (CPU) 10 having a function for creating the simulation model and a function for executing the circuit simulation, the input device 40 for inputting element information, the storage device 20 for storing the circuit simulation program, the process data, and the simulation model, and the display device 50 and the output device 60 for outputting the simulation results and an AHDL model. Depending on the input device 40, the element information may be at least one or all selected from the group consisting of element size, layout pattern, element arrangement conditions, and element grouping information, and a keyboard or a mouse, for example, can be used for the input device 40.

For the storage device 20 it is possible to use a hard disk (magnetic storage medium), RAM (memory), an optical storage medium, a magneto-optical storage medium or the like. Various types of means can be implemented with the CPU 10 by activating the program stored in the storage medium 20. The display device 50 can be a CRT, a liquid crystal display, an organic EL display or the like, and the output device 60 can be a printer, for example.

The circuit simulation device according to this embodiment has a function with which element parameters including the variation information can be set for each semiconductor production process or for each design rule. Thus, a circuit simulation for a 0.25 μm or 0.18 μm CMOS process, for example, can be executed simply, resulting in an increase in convenience. Additionally, the circuit simulation device of this embodiment has a function of turning the set element parameter groupings into files and varying the element parameters by a prescribed method, so that variations in circuit properties caused by variations between elements can be simulated.

The circuit simulation method of this embodiment can also be implemented by a circuit simulation program for achieving the following functions (a) to (e) on a computer.

(a) Function of editing the netlist stored in the storage device 20 included in the computer by using the element information input with the input device 40.

(b) Function of creating a simulation model for each of the elements including variation information by editing at least one or all selected from the group consisting of property parameters of each of the elements, correlating data between parameters, variation width of each of the elements, and the conditions for parameter fluctuation due to the element arrangement, using the process data stored in the storage device 20 and element information.

(c) Function of setting simulation conditions selected from the group consisting of the circuit simulation type, the power source voltage, the power source fluctuation value, and designating which parameter to vary.

(d) Function of executing the circuit simulation with a circuit simulation program stored in the storage device 20, based on the simulation conditions that have been set and the simulation model.

(e) Function of outputting the results of the circuit simulation to output means (the display device 50 or the output device 60).

In addition to the functions (a) to (e), the circuit simulation program can also be provided with a function for storing simulation conditions when executing the circuit simulation, automatically changing the stored simulation conditions, and then repeatedly performing the process for executing the circuit simulation. Also, function (e) can be provided with the function of outputting the results of the circuit simulation as an AHDL model. This circuit simulation program is stored on a storage medium readable by a computer, and can be manufactured, used, assigned, leased and the like. Examples of a storage medium readable by a computer include optical storage mediums and magneto-optical storage mediums such as CD-ROM, DVD, and MO, floppy disks, and memory cards.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description. All changes that come within the meaning and range of equivalency of the claims are intended to be embraced therein.

What is claimed is:

1. A circuit simulation method for a semiconductor device in which a circuit configuration is specified by a netlist, comprising the steps of:
formulating variations corresponding to a layout pattern and an arrangement of elements used in the semiconductor device into an equation including parameters;
putting the parameters included in the equation into element parameter groupings corresponding to each element, and storing the element parameter groupings in storage means;
varying parameters in the element parameter groupings, in accordance with conditions obtained from variations in a manufacturing process with respect to the semiconductor device; and
executing a circuit simulation with processing means using the varied parameters.

2. The circuit simulation method according to claim 1, wherein the step of allowing relative error parameters expressed using a size of proximate elements and a relative distance between proximate elements to be included in the element parameter groupings is executed when putting the parameters included in the equation into the element parameter groupings corresponding to each element.

3. The circuit simulation method according to claim 2, wherein the relative error parameters include variations in a wafer surface, variations between wafers, and variations between lots in the manufacturing process.

4. The circuit simulation method according to claim 1, wherein the step of executing a circuit simulation comprises the steps of:
creating a simulation model including variations corresponding to layout parameters and arrangement of elements used in the semiconductor device, element size, distance between elements, and the manufacturing process; and
executing a circuit simulation using the simulation model.

5. The circuit simulation method according to claim 1, wherein the formulating step further comprises a fitting step of fitting the parameters to conform to actual element properties, and
wherein the fitting step includes the step of arbitrarily setting a fitting precision during fitting.

6. The circuit simulation method according to claim 4, wherein the step of creating a simulation model further comprises a fitting step of fitting the parameters to conform to actual element properties, and
wherein the fitting step includes the step of arbitrarily setting a fitting method and a fitting precision during fitting.

7. The circuit simulation method according to claim 1, wherein arbitrary parameters of the parameters are provided with values related to each other.

8. The circuit simulation method according to claim 1, wherein the parameters of each element are grouped as an arbitrary group, and the parameters are varied at each of the groups.

9. The circuit simulation method according to claim 2 or 3, wherein the relative error parameters are grouped as an arbitrary group, and the parameters are varied at each of the groups.

10. The circuit simulation method according to claim 1, wherein the elements in the circuit to be simulated are grouped as an arbitrary group and predetermined parameters in a predetermined group are varied to an arbitrary precision and in an arbitrary range.

11. The circuit simulation method according to claim 1, wherein a predetermined number of simulations are performed after the parameters are varied at pre-designated ranges and conditions, and then results output for a designated site on the circuit are monitored and sensitivity with respect to the monitored site is analyzed.

12. The circuit simulation method according to claim 1, wherein sequentially changed values are set for the parameters.

13. The circuit simulation method according to claim 1, further comprising the step of performing numerical simulation of the circuit output obtained by the step of executing the circuit simulation, and outputting using function description language.

14. The circuit simulation method according to claim 1, wherein the semiconductor device in which a circuit configuration is specified by the netlist includes an analog circuit or an analog/digital mixed circuit.

15. A circuit simulation device, comprising:
input means for inputting at least one of or all element information selected from the group consisting of element size, layout pattern, element arrangement conditions, and element grouping information;
process data storage means for storing process data including element conditions for defining an element included in a semiconductor device to be manufactured and variations thereof;
processing means for creating, based on the process data and the element information, a simulation model including at least one of or all simulation model parameters selected from the group consisting of property parameters of each element, correlating data between parameters, variation width of each element, element arrangement parameters, and fluctuation conditions for each parameter; and
simulation model storage means for storing the simulation model,
wherein the processing means uses the simulation model and the netlist specifying the circuit configuration of the semiconductor device to be manufactured in order to execute a circuit simulation.

16. The circuit simulation device according to claim 15, wherein the circuit simulation device further includes the functions of:
enabling element parameters corresponding to a layout pattern and arrangement of each element used in the semiconductor device, and including variation information, to be set for each semiconductor manufacturing process or for each design rule; and
turning the set element parameter groupings into files and varying the element parameters by a prescribed method, and then simulating variations in circuit properties caused by variations between elements.

17. The circuit simulation device according to claim 15, wherein the circuit simulation device further comprises:
netlist creating means for creating a netlist specifying a circuit configuration of a semiconductor device to be manufactured;
netlist editing means for editing the netlist by using the element information input by the input means; and
simulation condition setting means for setting the simulation conditions when executing the circuit simulation.

18. The circuit simulation device according to claim 15, further comprising simulation condition storage means for storing simulation conditions,
wherein the simulation condition setting means has a function of enabling the simulation conditions stored in the simulation condition storage means to be changed; and
wherein the processing means repeatedly executes a circuit simulation based on the simulation conditions or simulation conditions that have been changed by the simulation condition setting means.

19. The circuit simulation device according to claim 15, further comprising output means for outputting results obtained from the circuit simulation executed by the processing means.

20. The circuit simulation device according to claim 19, wherein the output means outputs the results of the execution as an AHDL model including the variations in circuit properties.

21. A circuit simulation method, comprising the steps of:
creating a netlist specifying a circuit configuration of a semiconductor device by circuit netlist creating means;
inputting at least one of or all element information selected from the group consisting of element size, layout pattern, element arrangement conditions, and element grouping information by input means;
editing the netlist with circuit netlist editing means, using the element information inputted by the input means;
creating a simulation model for each element including variation information with processing means by using the element information and process data that are stored in process data storage means and include element conditions for defining an element included in the semiconductor device to be manufactured and variations thereof;
storing the created simulation model in storage means;
using the netlist edited with the circuit netlist editing means and the simulation model stored in the storage means to execute a circuit simulation with the processing means for executing a circuit simulation program; and
outputting results of the circuit simulation to output means.

22. The circuit simulation method according to claim 21, wherein the step of creating a simulation model is creating a simulation model that has at least one of or all simulation model parameters selected from the group consisting of property parameters of each element, correlating data between parameters, variation width of each element, element arrangement parameters, and fluctuation conditions for each parameter.

23. The circuit simulation method according to claim 21, wherein the step of setting simulation conditions selected from the group consisting of circuit simulation type, power source voltage, power source fluctuation value, and designating which parameter to vary is executed before the step of performing the circuit simulation is executed.

24. The circuit simulation method according to claim 23, wherein the step of setting the simulation conditions is executed after the outputted results for the circuit simulation are evaluated, and then the step of performing the circuit simulation once again is executed.

25. The circuit simulation method according to claim 23, wherein the step of setting the simulation conditions is automatically executed after the step of performing the circuit simulation, and then the step of performing the circuit simulation is performed repeatedly.

26. The circuit simulation method according to claim 21, wherein the outputting step includes the step of outputting the results of the circuit simulation as an AHDL model.

27. The circuit simulation method according to claim 21, wherein the step of creating the netlist is creating a netlist specifying the circuit configuration of a semiconductor device including an analog circuit or an analog/digital mixed circuit.

28. A circuit simulation program for implementation by a computer comprising the functions of:
editing a netlist stored in storage means included in the computer, using at least one of or all element information selected from the group consisting of element size, layout pattern, element arrangement conditions and element grouping information, the element information being inputted by input means;
creating a simulation model for each element including variation information, by editing at least one or all selected from the group consisting of property parameters of each element, correlating data between parameters, variation width of each element, and conditions for parameter fluctuation due to element arrangement, using the element information and process data that are stored in the storage means of the computer and include element conditions for defining an element included in a semiconductor device to be manufactured and variations thereof;
setting simulation conditions selected from the group consisting of circuit simulation type, power source voltage, power source fluctuation value, and designating which parameters to vary;
executing the circuit simulation by a circuit simulation program stored in the storage means, based on the set simulation conditions and the simulation model; and
outputting results of the circuit simulation to output means.

29. The circuit simulation program according to claim 28, wherein the netlist stored in the storage means is a netlist that specifies a circuit configuration of a semiconductor device including an analog circuit or an analog/digital mixed circuit.

30. The circuit simulation program according to claim 28, further comprising the function of storing simulation conditions when executing the circuit simulation, automatically changing the stored simulation conditions, and then repeatedly executing the step of performing the circuit simulation once again.

31. The circuit simulation program according to claim 28, wherein the function for outputting is provided with a function of outputting results of the circuit simulation as an AHDL model.

32. A storage medium readable by a computer, onto which the circuit simulation program according to claim 28 is stored.
